(19) United States
(12) Patent Application Publication
(10) Pub. No.: US 2015/0061923 A1
(43) Pub. Date: Mar. 5, 2015

(54) PHASE MONOPULSE RADAR SYSTEM AND TARGET DETECTING METHOD

(71) Applicant: TOYOTA JIDOSHA KABUSHIKI KAISHA, Toyota-shi, Aichi-ken (JP)

(72) Inventors: Yoh Sato, Miyoshi-shi (JP); Akihiro Yanai, Toyota-shi (JP); Kiyomi Nagamiya, Nisshin-shi (JP); Kazumichi Nishida, Toyota-shi (JP); Takashi Yamada, Okazaki-shi (JP); Masaru Ogawa, Seto-shi (JP)

(73) Assignee: TOYOTA JIDOSHA KABUSHIKI KAISHA, Toyota-shi, Aichi-ken (JP)

(21) Appl. No.: 14/390,208

(22) PCT Filed: Apr. 2, 2013
(86) PCT No.: PCT/IB2013/000573

§ 371 Date: Oct. 2, 2014

(30) Foreign Application Priority Data
Apr. 4, 2012 (JP) 2012-085870

(51) Int. Cl. G01S 7/28; G01S 13/02

(52) U.S. Cl. CPC G01S 7/28; G01S 13/02
USPC 342/149

(57) ABSTRACT

A phase monopulse radar system includes a transmitting antenna that transmits a transmission signal, a plurality of receiving antennas that receive reflected waves of the transmission signal as received signals, a target azimuth detecting unit that detects an azimuth of a target based on a phase difference of the received signals received by the receiving antennas, a phase inversion determining unit that determines whether a phase inversion occurs to any one of the received signals, at around a peak frequency of a frequency spectrum of the received signal, and a detection object excluding unit that does not use an azimuth based on the phase difference as a target azimuth, when the phase inversion determining unit determines that the phase inversion occurs.

### BACKGROUND OF THE INVENTION

1. Field of the Invention

The invention generally relates to a phase monopulse radar system and a target detecting method. In particular, the invention relates to a phase monopulse radar system adapted to detect an azimuth of a target based on a phase difference of received signals respectively received by two or more receiving antennas, and a target detecting method.

2. Description of Related Art

A phase monopulse radar system including a transmitting antenna that transmits a transmission signal, and two or more receiving antennas that receive reflected waves of the transmission signal reflected by a target, as received signals, is known (see, for example, Japanese Patent Application Publication No. 2003-248054 (JP 2003-248054)). The phase monopulse radar system receives reflected waves of the transmission signal, at the two or more receiving antennas, and calculates a phase difference between the received signals received by the two or more receiving antennas, so as to detect the azimuth of the target based on the calculated phase difference.

In the meantime, when the transmission signal is reflected at two or more different reflection points (e.g., two reflection points) on the same target, each of the receiving antennas receives reflected waves from these reflection points, as received signals. In this case, each of the received signals received by the two or more receiving antennas is a synthesis of the reflected waves from the respective reflection points. If the reflected waves from the respective reflection points are converted to low-frequency beat signals, which are then subjected to fast Fourier transformation (FFT), the peak frequencies at which the amplitude of the signal reaches its maximum, of the beat frequencies of the reflected waves, are different from each other, between the respective frequency spectra.

When a difference in the distance from the radar system to each reflection point is equal to or smaller than a distance resolution of the radar system, regions of frequency spectra of the amplitudes of the beat signals of the reflected waves from the respective reflection points overlap each other. In this case, it is difficult to discriminate the beat signals of the reflected waves from the two or more reflection points from each other. Namely, reflected wave as seen from the receiving antenna side appears to be reflected or transmitted from one intermediate point between the two or more reflection points.

However, where the distances between the reflection points and the radar system (i.e., the receiving antennas) change, the reflected waves from the two or more reflection points may interfere with each other; in this case, the reflected wave as seen from the receiving antennas side appears to be reflected or transmitted from a point whose azimuth is largely different from the azimuth of the intermediate point between the two or more reflection points, due to the interference of the reflected waves. In this case, the position of the target may be erroneously detected, and subsequent operations may not be appropriately continued.

### SUMMARY OF THE INVENTION

The invention provides a phase monopulse radar system and a target detecting method, which assure improved accuracy with which the azimuth of a target is detected.

A phase monopulse radar system according to a first aspect of the invention includes a transmitting antenna that transmits a transmission signal, a plurality of receiving antennas that receive reflected waves of the transmission signal as received signals, a target azimuth detecting portion that detects an azimuth of a target based on a phase difference of the received signals received by the above-indicated plurality of receiving antennas, a phase inversion determining portion that determines whether a phase inversion occurs to any one of the received signals, at around a peak frequency of a frequency spectrum of the received signal, and a detection object excluding portion that does not use an azimuth based on the phase difference as a target azimuth, when the phase inversion determining portion determines that the phase inversion occurs.

A phase monopulse radar system according to a second aspect of the invention includes a transmitting portion that transmits a transmission signal, a plurality of receiving portions that respectively receives reflected waves including the transmission signal reflected from a target, as received signals, a beat signal generating portion that generates beat signals from the received signals, a spectrum generating portion that generates a plurality of frequency spectra from the beat signals, an azimuth detecting portion that detects an azimuth of the target based on a phase difference between the above-indicated plurality of frequency spectra, and a phase inversion determining portion that determines whether a phase inversion occurs to any one of the received signals, within a predetermined frequency range including a frequency at which an amplitude of the received signal reaches a maximum in the corresponding frequency spectrum. In the phase monopulse radar system, the azimuth detecting portion does not use the phase difference for detection of the azimuth of the target, when the phase inversion determining portion determines that the phase inversion occurs.

A target detecting method according to a third aspect of the invention includes the steps of transmitting a transmission signal, receiving reflected waves including the transmission signal reflected from a target, as received signals, generating beat signals from the received signals, generating a plurality of frequency spectra from the beat signals, detecting an azimuth of the target based on a phase difference between the above-indicated plurality of frequency spectra, and determining whether a phase inversion occurs to any one of the received signals, within a predetermined frequency range including a frequency at which an amplitude of the received signal reaches a maximum in the corresponding frequency spectrum. In this method, the phase difference is not used for detection of the azimuth of the target, when it is determined that the phase inversion occurs to any one of the received signals.

According to the above aspects of the invention, the accuracy with which the azimuth of the target is detected can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of a phase monopulse radar system according to a first embodiment of the invention;

FIG. 2A is a view showing the relationship between the phase difference and the azimuth, in a detection process of the phase monopulse radar system of the embodiment of FIG. 1;

FIG. 2B is a vector diagram of the phase difference, in the detection process of the phase monopulse radar system of the embodiment of FIG. 1;

FIG. 3 is a view useful for explaining occurrence of an error in detection of the azimuth in the phase monopulse radar system;

FIG. 4 is a view showing the amplitude and phase of a beat signal of a received signal obtained by receiving reflected wave from each reflection point, in the case where two reflection points are present on a target that reflects a transmission signal, and the amplitude and phase of synthetic wave into which the received signals from the respective reflection points are synthesized;

FIG. 5 is a flowchart illustrating one example of control routine executed by the phase monopulse radar system of this embodiment;

FIG. 6A is a view showing changes in the phase difference in the received signal into which reflected waves from the respective reflection points are synthesized, between two receiving antennas, with respect to the frequency, when no phase inversion occurs at around the peak frequency of the received signals;

FIG. 6B is a, view showing changes in the phase difference with respect to the frequency, when a phase inversion occurs at around the peak frequency of the received signals;

FIG. 7A is a view showing results of target azimuth detection obtained by a phase monopulse radar system as a comparative system;

FIG. 7B is a view showing results of target azimuth detection obtained by the phase monopulse radar system of the embodiment of FIG. 1;

FIG. 8 is a block diagram of a phase monopulse radar system according to a second embodiment of the invention;

FIG. 9A is a phasor diagram showing variations in the phases of the received signals into which reflected waves from the respective reflection points are synthesized and which are received by the receiving antennas, with respect to the frequency around the peak frequency, when no phase inversion occurs at around the peak frequency of the received signals; and

FIG. 9B is a phasor diagram showing variations in the phases of the received signals, with respect to the frequency, when a phase inversion occurs at around the peak frequency of the received signals.

### DETAILED DESCRIPTION OF EMBODIMENTS

Referring to the drawings, specific embodiments of the invention in the form of phase monopulse radar systems will be described.

### First Embodiment

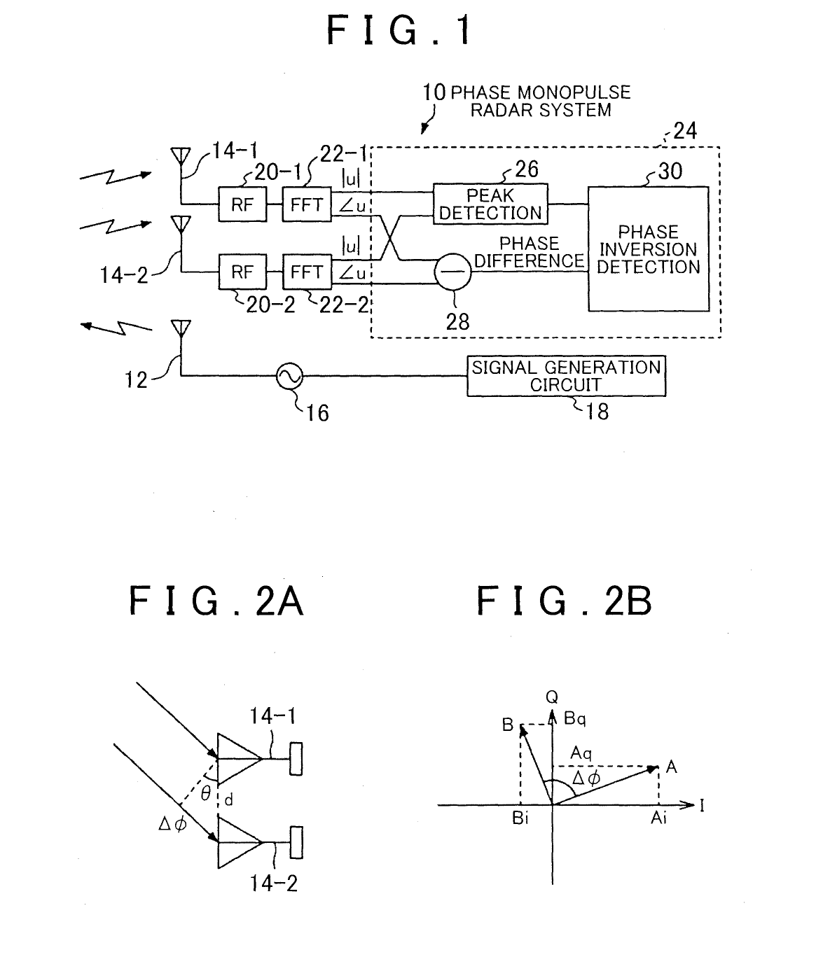

FIG. 1 is a block diagram of a phase monopulse radar system 10 as a first embodiment of the invention. The phase monopulse radar system 10 of this embodiment is installed on a vehicle, for example, and is operable to detect a distance between the vehicle and an object (target) that exists around the vehicle (e.g., in front of, in the rear of, or at one side of the vehicle), and an azimuth (angle) θ of the object. The phase monopulse radar system 10 is applied to, for example, an FM-CW type millimeter-wave radar system that detects the position (distance and azimuth) of a target relative to the vehicle.

As shown in FIG. 1, the phase monopulse radar system 10 includes a transmitting antenna 12 that transmits a transmission signal, and two receiving antennas 14-1, 14-2 that receive reflected waves of the transmission signal as received signals. A signal generation circuit 18 is connected to the transmitting antenna 12 via an oscillator 16. The signal generation circuit 18 controls the oscillator 16 so as to generate a desired transmission signal, and causes the thus generated transmission signal to be transmitted from the transmitting antenna 12. The transmission signal is transmitted from the transmitting antenna 12 to within a given detection zone around the vehicle. If a target exists in the given detection zone around the vehicle, the transmission signal transmitted from the transmitting antenna 12 is reflected by the target, and returns to the phase monopulse radar system 10.

The phase monopulse radar system 10 includes two receiving antennas 14-1, 14-2. If the transmission signal from the transmitting antenna 12 is reflected by the target, reflected waves are received as received signals by the two receiving antennas 14-1, 14-2.

A high-frequency (RF) circuit 20-1 is connected to the receiving antenna 14-1, and a high-frequency (RF) circuit 20-2 is connected to the receiving antenna 14-2. Each of the high-frequency circuits 20-1, 20-2 converts the received signal received by a corresponding one of the receiving antennas 14-1, 14-2, into a low-frequency beat signal, using the transmission signal. An FFT operation unit (signal analyzing unit) 22-1 is connected to the high-frequency circuit 20-1, and an FFT operation unit 22-2 is connected to the high-frequency circuit 20-2. Each of the FFT operation units 22-1, 22-2 performs FFT (fast Fourier transformation) on the beat signal from a corresponding one of the high-frequency circuits 20-1, 20-2. With the FFT performed on the beat signal, a frequency spectrum indicating the amplitude |u| and phase <u of the beat signal with respect to the frequency is generated.

A target detecting unit 24 is connected to the FFT operation units 22-1, 22-2. The target detecting unit 24 has a peak detecting unit 26 and a phase difference detecting unit 28. The peak detecting unit 26 is supplied with frequency spectrum data indicating the amplitude |u| with respect to the frequency, which data is obtained by each of the FFT operation units 22-1, 22-2. The peak detecting unit 26 detects the amplitude |u|, with respect to the frequency, of the beat signal of each of the received signals received by the receiving antennas 14-1, 14-2, based on the frequency spectrum data of each of the received signals received by the receiving antennas 14-1, 14-2, and calculates the frequency (peak frequency) at which the amplitude |u| reaches its maximum.

The phase difference detecting unit 28 is supplied with frequency spectrum data indicating the phase <u with respect to the frequency, which data is obtained by each of the FFT operation units 22-1, 22-2. The phase difference detecting unit 28 calculates a phase difference Δφ of the beat signals of the respective received signals received by the receiving antennas 14-1, 14-2, based on the frequency spectrum data for each of the received signals received by the receiving antennas 14-1, 14-2.

The target detecting unit 24 detects the distance from the vehicle to the target, based on the peak frequency of the beat signals of the received signals received by the receiving antennas 14-1, 14-2, and detects the azimuth (angle) of the target that exists around the vehicle, based on the phase difference Δφ of the beat signals of the respective received signals received by the receiving antennas 14-1, 14-2.

The target detecting unit 24 also includes a phase inversion detecting unit 30 connected to the peak detecting unit 26 and the phase difference detecting unit 28. The phase inversion detecting unit 30 is supplied with peak frequency data of the received signals at the receiving antennas 14-1, 14-2, and phase difference Δφ data of these received signals. The phase inversion detecting unit 30 determines whether a phase inversion occurs to any one of the two received signals at around the peak frequency, based on the peak frequency and the phase difference Δφ.

FIG. 2A and FIG. 2B are views useful for explaining an azimuth detecting operation performed by the phase monopulse radar system 10 of this embodiment. FIG. 2A shows the relationship between the receiving phase difference Δφ between the two receiving antennas 14-1, 14-2 and the azimuth θ. FIG. 2B is a vector diagram of the receiving phase difference Δφ between the two receiving antennas 14-1, 14-2.

The phase difference Δφ of the two beat signals at the receiving antennas 14-1, 14-2 is expressed by the following equation (1). In Eq. (1), λ is the wavelength of radio wave, and d is the distance between the receiving antennas 14-1, 14-2.

$$Δ φ = \frac{2 \cdot π \cdot d \cdot sin θ}{λ} \qquad ( 1 )$$

The phases of the peak frequencies of the beat signals of the respective receiving antennas 14-1, 14-2, which signals have been subjected to FFT (fast Fourier transformation), are expressed in the form of vectors (vector A and vector B) on the real/imaginary axes as shown in FIG. 2B. Thus, the receiving phase difference Δφ between the two receiving antennas 14-1, 14-2 is expressed by the following equation (2).

$$cos Δ φ = \frac{\overline{A} \cdot \overline{B}}{\vert \overline{A} \vert \vert \overline{B} \vert} = \frac{Ai \cdot Bi + Aq \cdot Bq}{\sqrt{{Ai}^{2} + {Aq}^{2}} \cdot \sqrt{{Bi}^{2} + {Bq}^{2}}} \qquad ( 2 )$$

Accordingly, in this embodiment, the target detecting unit 24 detects the azimuth (angle) θ, according to the following equation (3) obtained from the above-indicated equations (1) and (2).

$$θ = {sin}^{- 1} ( \frac{λ}{2 \cdot π \cdot d} \cdot {cos}^{- 1} ( \frac{Ai \cdot Bi + Aq \cdot Bq}{\sqrt{{Ai}^{2} + {Aq}^{2}} \cdot \sqrt{{Bi}^{2} + {Bq}^{2}}} ) ) \qquad ( 3 )$$

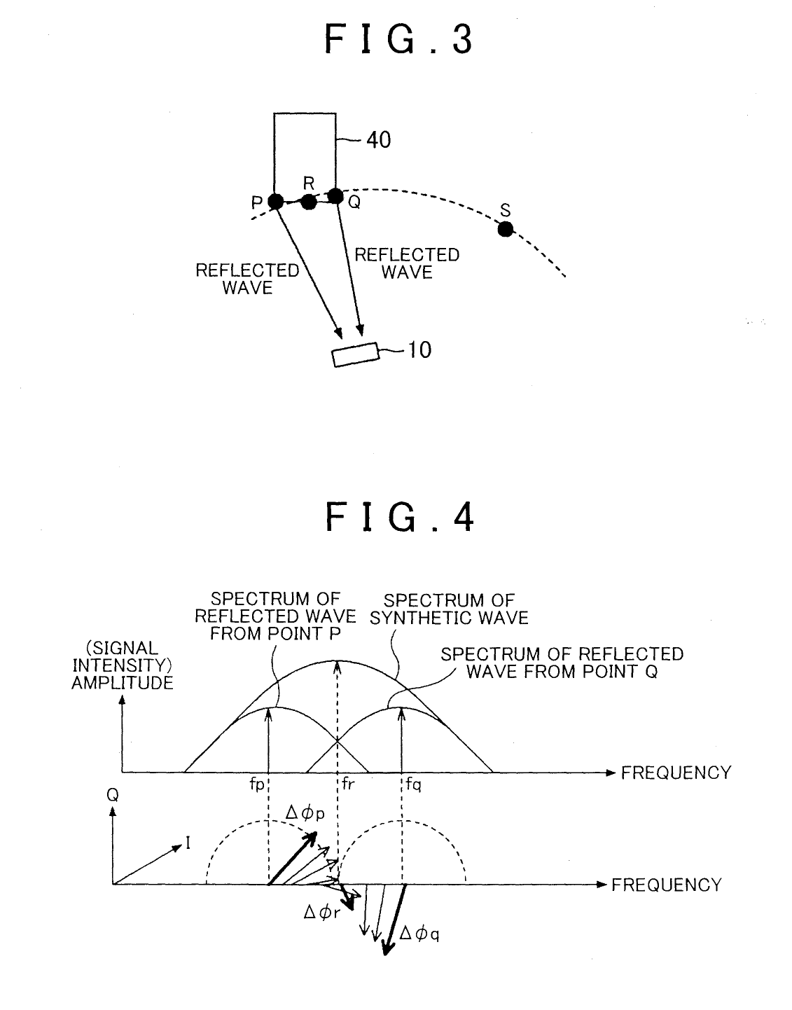

FIG. 3 is a view useful for explaining occurrence of an error in azimuth detection in the phase monopulse radar system. FIG. 4 shows the case where the target has two reflection points at which the transmission signal is reflected. More specifically, FIG. 4 shows the amplitude and phase of the beat signal of the received signal obtained by receiving reflected wave from each of the reflection points, and the amplitude and phase of synthetic wave into which the received signals from the respective reflection points are synthesized.

When the transmission signal transmitted from the transmitting antenna 12 is reflected at two or more different points (which will be called “reflection point P” and “reflection point Q”) on the same target 40, the phase monopulse radar system 10 receives, at each of the receiving antennas 14-1, 14-2, reflected waves reflected at the reflection points P, Q, respectively, as received signals. If the reflected waves from the reflection points P, Q are respectively converted to beat signals and subjected to FFT, a peak in the amplitude appears in the frequency spectrum of each beat signal with respect to each of the reflection points P, Q, as shown in the upper graph of FIG. 4. Namely, the peak frequencies fp, fq at which the amplitudes of the received signals from the reflection points P, Q are maximized are different from each other.

In the case where a difference between the distance between the phase monopulse radar system 10 and the reflection point P and the distance between the phase monopulse radar system 10 and the reflection point Q is equal to or smaller than the distance resolution of the phase monopulse radar system 10, the regions or zones of the frequency spectra of the beat signals of the reflected waves from the respective reflection points P, Q overlap each other, as shown in the upper graph of FIG. 4. In this situation, the received signals actually received by the receiving antennas 14-1, 14-2 are synthetic waves into which the reflected waves from the respective reflection points P, Q are synthesized; therefore, in the frequency spectrum of the beat signal of the actually received signal, an amplitude peak appears at a frequency fr intermediate between the above-indicated peak frequencies fp, fq.

Generally, the phases of the received signals of the two receiving antennas 14-1, 14-2 do not change so largely, in the vicinity of the peak frequency fr of the received signal into which the reflected waves from the reflection points P, Q are synthesized. In this case, the phase difference Δφ does not change so largely, and becomes equal to an intermediate value between a phase difference Δφp associated with the reflection point P and a phase difference Δφq associated with the reference point Q. Namely, if synthetic waves into which the reflected waves from the two reflection points P, Q are synthesized are received as received signals by the receiving antennas 14-1, 14-2, reflected wave as seen from the radar system 10 appears to be reflected or transmitted from point R that is located midway between the two reflection points P, Q.

However, if the reflected waves from the reflection points P, Q interfere with each other, for example, any one of the received signals of the receiving antennas 14-1, 14-2 may be inverted 360°, at around the peak frequency fr of the above-described synthetic wave, due to the interference of the reflected waves, and the phase difference Δφ of the received signals may largely change. In this case, if the synthetic waves into which the reflected waves from the two reflection points P, Q are synthesized are received as received signals by the receiving antennas 14-1, 14-2, reflected wave as seen from the phase monpulse radar system 10 appears to be reflected or transmitted from point S, the azimuth of which is largely different from the azimuth of point R located midway between the two reflection points P, Q. In this case, it is determined that the target is located in the direction of point S, the azimuth of which is largely different from that of point R located between the two reflection points P, Q. If the azimuth of the target is erroneously detected in this way, a subsequent control operation (e.g. a target tracking operation or a moving locus estimating operation, or collision avoidance control, such as an alarm output or a forced brake) may not be appropriately continued.

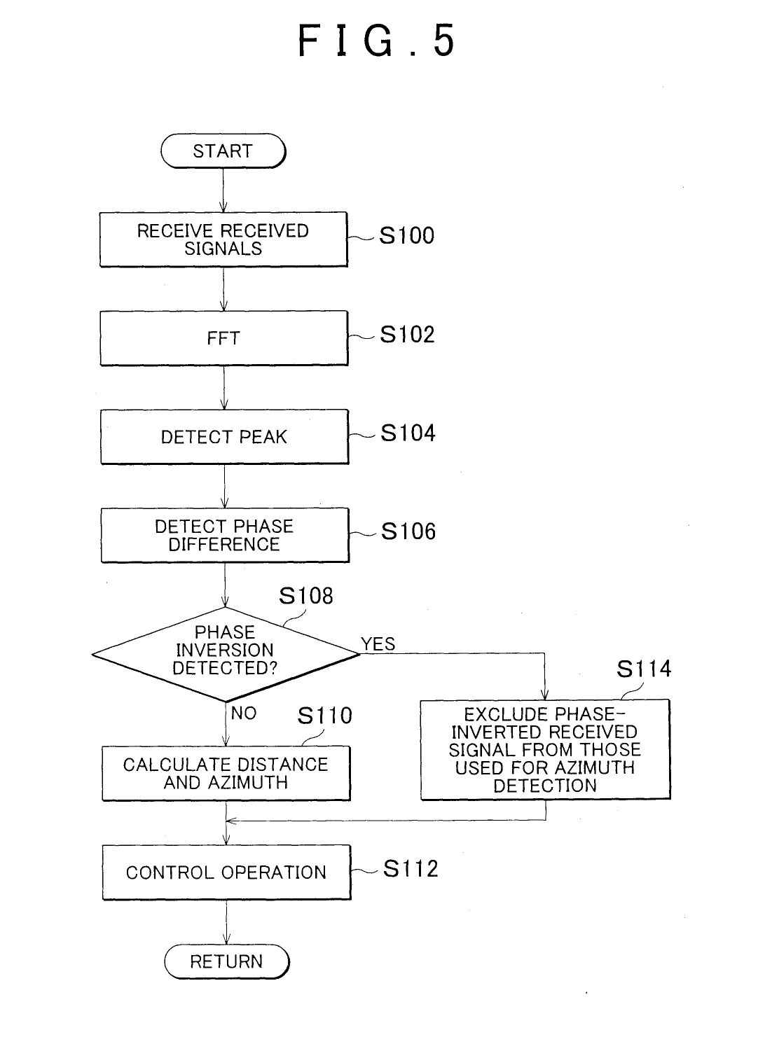

Thus, in this embodiment, when a phase inversion occurs to any one of the received signals received by the two receiving antennas 14-1, 14-2, at or near the peak frequency fr of the beat signal of the received signal, the received signals including at least the received signal to which the phase inversion occurred are not used for detection of the target azimuth, namely, the azimuth detected based on a phase difference of the two received signals is not used as the azimuth direction in which the target is located relative to the vehicle, thus assuring improved accuracy in detection of the target azimuth. Referring to FIG. 5 through FIG. 7, features of this embodiment will be described.

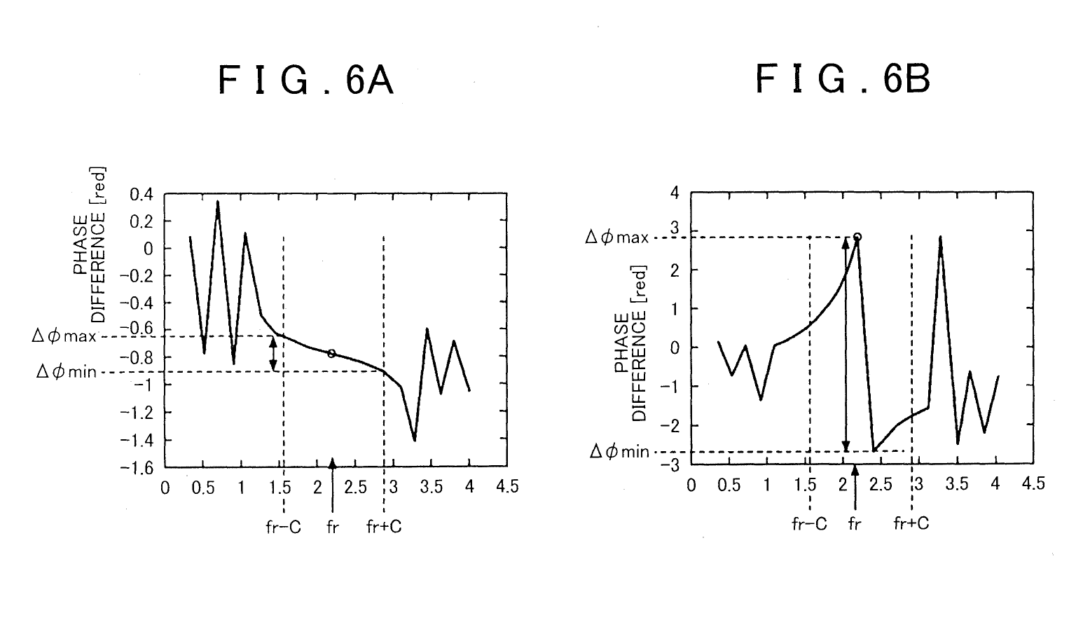

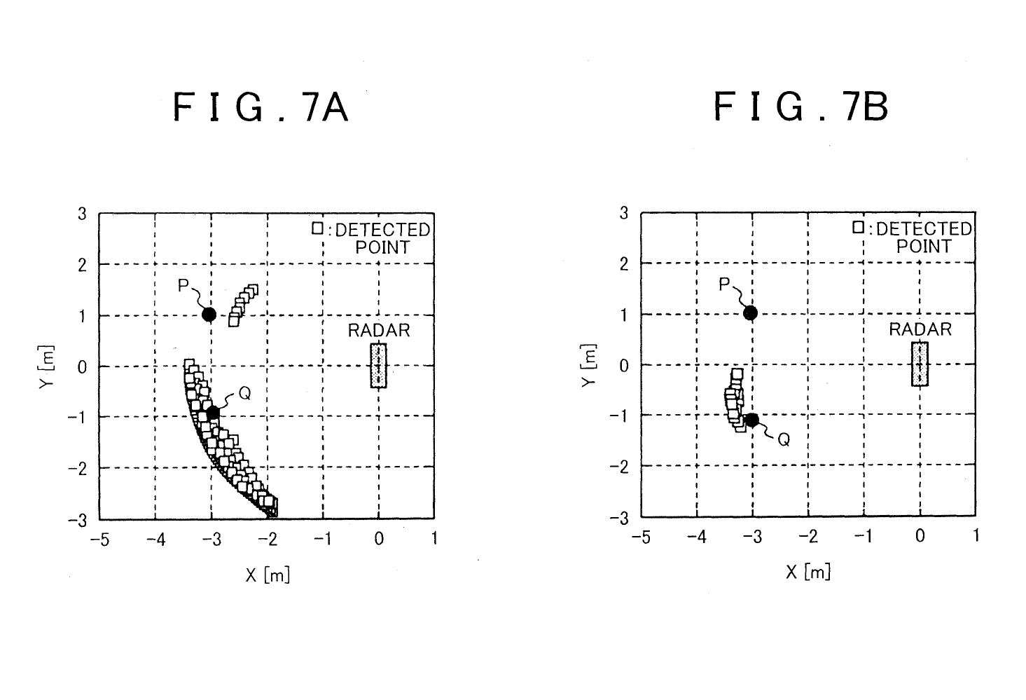

FIG. 5 is a flowchart of one example of control routine executed by the phase monopulse radar system 10 of this embodiment. FIG. 6A shows changes in the phase difference of the received signals into which the reflected waves from the respective reflection points are synthesized, between the receiving antennas 14-1, 14-2, with respect to the frequency, in the case where no phase inversion occurs at around the peak frequency of the received signals. FIG. 6B shows changes in the phase difference with respect to the frequency in the case where a phase inversion occurs at or near the peak frequency of the received signals, for comparison with FIG. 6A. FIG. 7A and FIG. 7B are used for explaining the effect provided by the phase monopulse radar system 10 of this embodiment. FIG. 7A shows the results of target azimuth detection, which were obtained by a comparative system to be compared with the phase monopulse radar system 10 of this embodiment. FIG. 7B shows the results of target azimuth detection, which were obtained by the phase monopulse radar system 10 of this embodiment.

In the phase monopulse radar system 10 of this embodiment, after a transmission signal is radiated from the transmitting antenna 12, the transmission signal is reflected by a target, and its reflected wave is received by the receiving antennas 14-1, 14-2, as received signals (step 100). Then, the received signals of the respective receiving antennas 14-1, 14-2 are converted to low-frequency beat signals in the high-frequency circuits 20-1, 20-2, respectively, and the beat signals are subjected to FFT (fast Fourier transformation), to be converted to frequency spectra (step 102).

Amplitude data of the frequency spectra of the respective received signals received by the receiving antennas 14-1, 14-2 are supplied to the peak detecting unit 26. The peak detecting unit 26 calculates the peak frequency fr at which the amplitude reaches its maximum in each received signal, based on the amplitude data of the received signal (step 104). Also, phase data of the frequency spectra of the respective received signals are supplied, to the phase difference detecting unit 28. The phase difference detecting unit 28 calculates a difference (phase difference) Δφ of the phases of these received signals at each frequency, based on the phase data of the respective received signals (step 106).

Data of the peak frequency fr and phase difference Δφ calculated as described above are supplied to the phase inversion detecting unit 30. The phase inversion detecting unit 30 determines whether a phase inversion occurs to any one of the received signals received by the receiving antennas 14-1, 14-2, at around the peak frequency fr, based on the peak frequency fr of the received signals calculated by the peak detecting unit 26, and the phase difference Δφ calculated by the phase difference detecting unit 28 (step 108).

If no phase inversion occurs to any of the received signals received by the two receiving antennas 14-1, 14-2 at around the peak frequency fr of the received signals, the phase difference Δφ of the received signals does not vary largely at around the peak frequency fr thereof, as shown in FIG. 6A. On the other hand, if a phase inversion occurs to any one of the received signals, the phase difference Δφ of the received signals varies largely at around the peak frequency fr, due to the phase inversion, as shown in FIG. 6B.

In the above-described step 108 of determining whether a phase inversion occurs, the phase inversion detecting unit 30 initially searches phase differences Δφ of the received signals in the vicinity of the above-indicated peak frequency fr. More specifically, the phase inversion detecting unit 30 obtains the maximum value Δφmax and minimum value Δφmin of the phase difference Δφ of the received signals, within a predetermined frequency range or zone (fr−C to fr+C) centered at the above-indicated peak frequency fr. Then, it is determined whether a difference between the maximum value Δφmax and the minimum value Δφmin of the phase difference Δφ is equal to or larger than a given threshold value. The given threshold value may be the smallest value that can be produced as a phase difference of the received signals when the phase of any one of the received signals received by the receiving antennas 14-1, 14-2 is inverted 360°.

When the phase inversion detecting unit 30 determines that the difference between the maximum value Δφ max and the minimum value Δφmin of the phase difference Δφ is not equal to or larger than the given threshold value, it determines that both of the received signals received by the receiving antennas 14-1, 14-2 do not undergo phase inversion at around the peak frequency fr. On the other hand, if the phase inversion detecting unit 30 determines that the difference between the maximum value Δφmax and the minimum value Δφmin of the phase difference Δφ is equal to or larger than the given threshold value, it determines that any one of the received signals received by the receiving antennas 14-1, 14-2 undergoes phase inversion at around the peak frequency fr.

When the phase inversion detecting unit 30 determines in the above-described step 108 that no phase inversion occurs to any of the received signals received by the receiving antennas 14-1, 14-2, at around the peak frequency fr of the received signal, the target detecting unit 24 normally calculates the distance and azimuth of the target that exists around the vehicle, based on the peak frequency fr and phase difference Δφ of the received signals received by the receiving antennas 14-1, 14-2, so as to determine the position of the target (step 110). Then, a control operation is performed based on the detected target position (step 112). The control operation may be selected from, for example, a tracking operation to track the target, using the detected target position, a moving locus estimating operation to estimate the moving locus of the target, and collision avoidance control, such as an alarm output and forced brake, based on the target position.

On the other hand, if the phase inversion detecting unit 30 determines in the above step 108 that a phase inversion occurs to any one of the received signals received by the receiving antennas 14-1, 14-2, at around the peak frequency fr of the received signal, the target detecting unit 24 excludes both of the received signals from received signals used for detecting the azimuth of the target, and does not use the azimuth detected based on the phase difference Δφ of these received signals as the target azimuth used in the following control operation (step 114). When the operation to exclude the received signals from those used for detecting the azimuth is performed, the control operation is performed without using the azimuth based on these received signals (for example, the control operation is continued using past received signals, or the control operation itself is interrupted or cancelled).

Thus, in the phase monopulse radar system 10 of this embodiment, when the difference between the maximum value Δφmax and the minimum value Δφmin of the phase difference Δφ of the received signals, within the predetermined frequency range or zone (fr−C to fr+C) centered at the peak frequency fr of the frequency spectra of the received signals received by the two receiving antennas 14-1, 14-2, is smaller than the given threshold value (namely, when the amount of change in the phase difference Δφ of the received signals in the vicinity of the peak frequency fr is smaller than a given value), it is determined that no phase inversion occurs to any of the received signals at around the peak frequency fr, and the azimuth direction in which the target exists is normally detected based on the phase difference Δφ of the received signals. In this case, the control operation is performed using the detected azimuth as the target azimuth.

On the other hand, when the difference between the maximum value Δφmax and the minimum value Δφmin of the phase difference Δφ of the received signals within the predetermined frequency range or zone (fr−C to fr+C) centered at the above-described peak frequency fr is equal to or larger than the given threshold value (namely, when the amount of change in the phase difference Δφ of the received signals in the vicinity of the peak frequency fr is equal to or larger than the given value), it is determined that a phase inversion occurs to any one of the received signals at around the peak frequency fr, and these received signals are excluded from received signals based on which the azimuth of the target is detected. In this case, the azimuth detected based on the phase difference Δφ of the received signals is not used as the target azimuth in the following control operation.

Thus, according to the phase monopulse radar system 10 of this embodiment, when the transmission signal transmitted from the transmitting antenna 12 is reflected by two or more reflection points (more specifically, two or more reflection points having small distance differences) on the same target, and synthetic waves into which reflected waves from the two or more reflection points are synthesized are received as received signals by the receiving antennas 14-1, 14-2, respectively, the two received signals received at the same time by the receiving antennas 14-1, 14-2 are not used for detection of the target azimuth if a phase inversion occurs to any one of the received signals received by the receiving antennas 14-1, 14-2, at around the peak frequency fr of the received signals.

According to the configuration of the system of this embodiment, the possibility that an azimuth direction that differs largely from the azimuth direction in which an intermediate point of two or more reflection points on the same target is located is used as the azimuth of the target can be reduced (see FIG. 7B), unlike the configuration of a system (see FIG. 7A) in which the received signals received by the receiving antennas 14-1, 14-2 are both used for detection of the target azimuth even when a phase inversion occurs to any one of these received signals at around the peak frequency fr thereof. Accordingly, with the phase monopulse radar system 10 of this embodiment, the azimuth of the target can be detected with improved accuracy. Consequently, the control operation using the detected azimuth of the target can be more appropriately carried out.

In the first embodiment as described above, the target detecting unit 24 functions as the target azimuth detecting portion of the present invention, and the operation of step 108 in the routine shown in FIG. 5 functions as the phase inversion determining portion of the invention, while the operation of step 114 functions as the detection object excluding portion of the invention.

### Second Embodiment

In the first embodiment as described above, it is determined whether a phase inversion occurs to any one of the received signals received by the two receiving antennas 14-1, 14-2, depending on whether the amount of change in the phase difference Δφ of the received signals in the vicinity of the peak frequency fr is equal to or larger than a given value (more specifically, whether the difference between the maximum value Δφmax and the minimum value Δφmin of the phase difference Δφ of the received signals is equal to or larger than a given threshold value). In the second embodiment of the invention, on the other hand, the occurrence of phase inversion as described above is determined by another method.

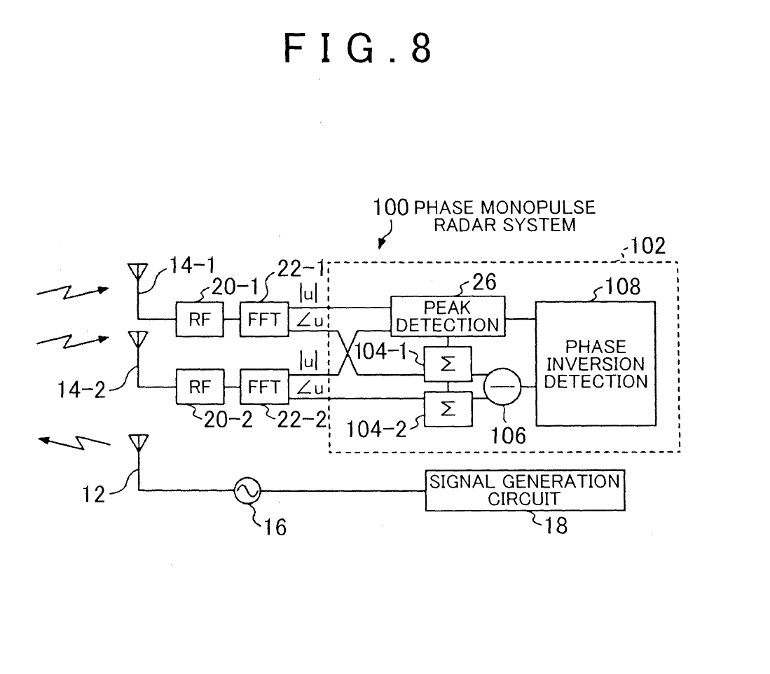

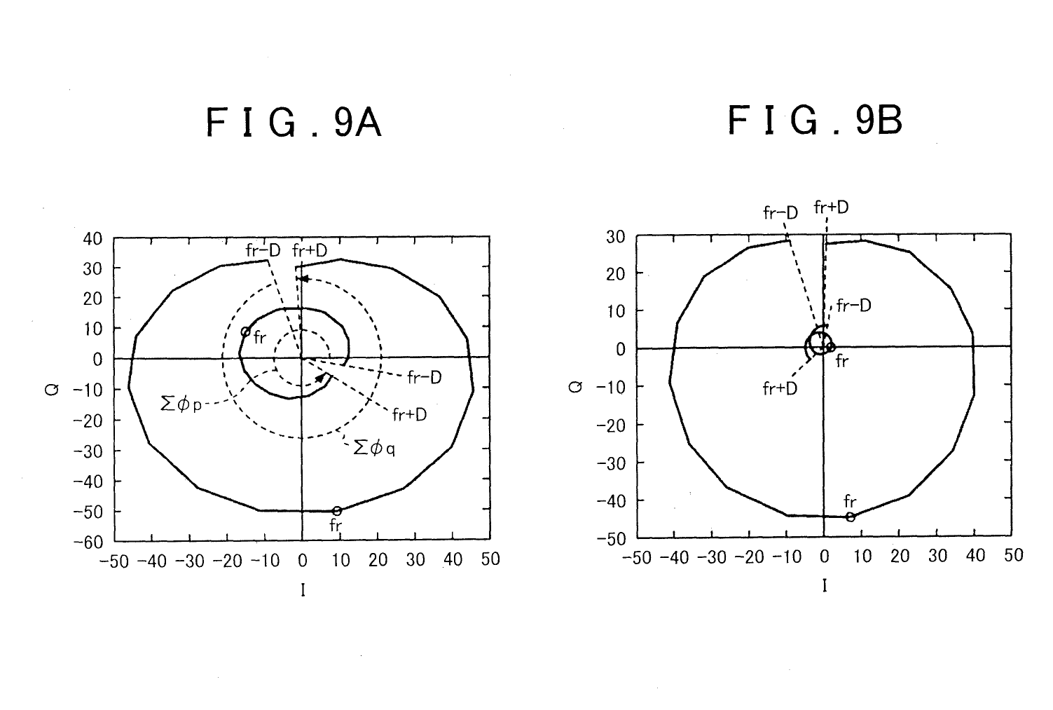

FIG. 8 is a block diagram of a phase monopulse radar system 100 according to the second embodiment of the invention. In FIG. 8, the same reference numerals as those used in FIG. 1 are assigned to the same or corresponding components or units as those of FIG. 1, of which further explanation will not be provided or only simple explanation will be provided. FIG. 9A and FIG. 9B are phasor diagrams showing variations in the phases of the received signals into which reflected waves from respective reflection points are synthesized at the two receiving antennas 14-1, 14-2, with respect to the frequency in a frequency zone (fr−C to fr+C) around the peak frequency fr. FIG. 9A shows the case where no phase inversion occurs at around the peak frequency fr of the received signals, and FIG. 9B shows the case where a phase inversion occurs at around the peak frequency fr of the received signals.

In the phase monopulse radar system 100 of this embodiment, a target detecting unit 102 is connected to the FFT operation units 22-1, 22-2. The target detecting unit 102 has a peak detecting unit 26 and a phase difference detecting unit (not shown). The target detecting unit 102 detects the distance from the vehicle to the target, based on the peak frequency of the beat signals of the received signals received by the receiving antennas 14-1, 14-2, and detects the azimuth (angle) θ of the target that exists around the vehicle, based on the phase difference Δφ of the beat signals of the respective received signals received by the receiving antennas 14-1, 14-2.

The target detecting unit 102 also includes an integrating unit 104-1 connected to the FFT operation unit 22-1, and an integrating unit 104-2 connected to the FFT operation unit 22-2. The above-mentioned peak detecting unit 26 is connected to the integrating units 104-1, 104-2. The integrating units 104-1, 104-2 are supplied with frequency spectrum data indicating the phase <u with respect to the frequency, which is obtained at the FFT operation unit 22-1, 22-2, and peak frequency data obtained at the peak detecting unit 26.

Each of the integrating units 104-1, 104-2 performs an operation to integrate variations in the phase of the beat signal of the received signal received by the corresponding receiving antenna 14-1, 14-2, in the vicinity of the peak frequency fr of the received signal. Namely, the integrating unit 104-1, 104-2 integrates variations in the phase of the beat signal of the corresponding received signal within a predetermined frequency range or zone (fr−D to fr+D) centered at the peak frequency fr of the received signal, for each of the received signals received by the receiving antennas 14-1, 14-2. With the integration thus performed, the integrated amount of phase variations in the received signal within the predetermined frequency range around the peak frequency fr is measured, with respect to each of the receiving antennas 14-1, 14-2.

An integral difference detecting unit 106 is connected to the integrating units 104-1, 104-2. The integral difference detecting unit 106 is supplied with integrated amount data of phase variations in the received signal within the predetermined frequency range around the peak frequency fr, for each of the receiving antennas 14-1, 14-2. The integral difference detecting unit 106 calculates a difference in the integrated amount of phase variations in the received signal within the same predetermined frequency range around the peak frequency fr, between the receiving antennas 14-1 14-2, based on the integrated amount data from the respective integrating units 104-1, 104-2.

The target detecting unit 102 also has a phase inversion detecting unit 108 connected to the peak detecting unit 26 and the integral difference detecting unit 106. The phase inversion detecting unit 108 is supplied with peak frequency data indicative of the peak frequency of the received signals received by the receiving antennas 14-1, 14-2, and difference data indicative of a difference between the integrated amounts of phase variations in the received signals as described above. The phase inversion detecting unit 108 determines whether a phase inversion occurs to any one of the received signals received by the receiving antennas 14-1, 14-2, at around the peak frequency fr, based on the peak frequency of the received signals calculated by the peak detecting unit 26, and the difference calculated by the integral difference detecting unit 106, in the integrated amount of phase variations in the received signal within the same predetermined frequency range around the peak frequency fr, between the receiving antennas 14-1, 14-2.

If no phase inversion occurs to any of the received signals received by the two receiving antennas 14-1, 14-2 at around the peak frequency fr of the received signals, a difference in the integrated amount of phase variations in each received signal around the peak frequency fr is not so large, as shown in FIG. 9A. On the other hand, if a phase inversion occurs, a difference in the integrated amount of phase variations in each received signal around the peak frequency fr is increased due to the phase inversion as shown in FIG. 9B.

The phase inversion detecting unit 108 determines whether a phase inversion occurs to any one of the received signals, by determining whether a difference in the integrated amount of phase variations in the received signal within the same predetermined frequency range around the peak frequency fr, between the receiving antennas 14-1, 14-2, is equal to or larger than a given value. The given value may be the minimum value that can be produced as a difference in the integrated amount of phase variations in each received signal within the predetermined frequency range when the phase of any one of the received signals received by the receiving antennas 14-1, 14-2 is inverted 360°.

When the phase inversion detecting unit 108 determines that no phase inversion occurs to any of the received signals received by the two receiving antennas 14-1, 14-2 at around the peak frequency fr, by determining that the difference in the integrated amount of phase variations as described above is smaller than the given value, the target detecting unit 102 normally calculates the distance and azimuth of the target around the vehicle so as to determine the position of the target, and the control operation is performed based on the detected target position.

On the other hand, when the phase inversion detecting unit 108 determines that a phase inversion occurs to any one of the received signals received by the two receiving antennas 14-1, 14-2 at around the peak frequency fr, by determining that the difference in the integrated amount of phase variations as described above is equal to or larger than the given value, the target detecting unit 102 excludes the received signals including at least the received signal to which the phase inversion occurred, from received signals based on which the azimuth is detected, and does not use the azimuth detected based on the phase difference Δφ of the received signals, as the target azimuth used in the control operation.

Thus, in the phase monopulse radar system 100 of this embodiment, when the difference in the integrated amount of phase variations in the received signal within the same predetermined frequency range or zone (fr−D to fr+D) around the peak frequency fr, between the two receiving antennas 14-1, 14-2, is smaller than the given value, it is determined that no phase inversion occurs to any of the received signals at around the peak frequency fr; in this case, the azimuth direction in which the target exists is normally detected based on the phase difference Δφ of the received signals, and the control operation is performed using the detected azimuth as the azimuth of the target.

On the other hand, when the difference in the integrated amount of phase variations in the received signal within the same predetermined frequency range (fr−D to fr+D) around the peak frequency fr, between the two receiving antennas 14-1, 14-2, is equal to or larger than the given value, it is determined that a phase inversion occurs to any one of the received signals at around the peak frequency fr; in this case, the received signals including at least the received signal to which the phase inversion occurred are excluded from received signals based on which the azimuth is detected, and the azimuth detected based on the phase difference Δφ of the two received signals is not used as the target azimuth for use in the control operation.

Therefore, in the phase monopulse radar system 100 of this embodiment, too, in the case where the transmission signal transmitted from the transmitting antenna 12 is reflected by two or more reflection points (more specifically, two or more reflection points having small distance differences) on the same target, and synthetic waves into which reflected waves from the two or more reflection points are synthesized are received as received signals by the receiving antennas 14-1, 14-2, respectively, if a phase inversion occurs to any one of the received signals received by the receiving antennas 14-1, 14-2 at around the peak frequency fr of the received signal, at least the received signal to which the phase inversion occurred or both of the received signals received at the same time by the receiving antennas 14-1, 14-2 is/are not used for detection of the target azimuth.

With the system of this embodiment configured as described above, the possibility that an azimuth direction that differs largely from the azimuth direction in which an intermediate point of two or more reflection points on the same target is located is used as the azimuth of the target can be reduced. Accordingly, in the phase monopulse radar system 100 of this embodiment, the target azimuth can be detected with improved accuracy. Consequently, the control operation using the detected target azimuth can be appropriately carried out.

In the above-described second embodiment, the target detecting unit 102 and the phase inversion detecting unit 108 that determine that a phase inversion occurs to any one of the received signals at around the peak frequency fr when a difference in the integrated amount of phase variations in the received signal within the same predetermined frequency range (fr−D to fr+D) around the peak frequency fr, between the two receiving antennas 14-1, 14-2, is equal to or larger than the given value functions as the phase inversion determining portion of the present invention.

In the above-described second embodiment, the integrated amount of phase variations in the received signal within the same predetermined frequency range (fr−D to fr+D) around the peak frequency fr is measured, and it is then determined whether a difference in the integrated amount between the two receiving antennas 14-1, 14-2 is equal to or larger than the given value, so as to determine that a phase inversion occurs to any one of the received signals at around the peak frequency fr if the difference is equal to or larger than the given value. However, the invention is not limited to this arrangement. For example, value D that specifies the frequency range or zone (fr−D to fr+D) may be appropriately set so that the integrated amount of phase variations in only the received signal received by the receiving antenna 14-1, 14-2 in which a phase inversion occurs exceeds 360° (2π). Then, if the phase locus of the received signal of one of the receiving antennas 14-1, 14-2 is arranged to rotate by 360° (2π) and intersect when a phase inversion occurs to the receiving signal, it may be determined whether a phase inversion occurs to any one of the received signals at around the peak frequency fr, based on whether the phase locus rotates by 360° (2π) or more and intersects, without measuring the above-described integrated amount.

In the first and second embodiments, the phase monopulse radar system 10, 100 includes two receiving antennas 14-1, 14-2. However, the invention is not limited to this arrangement, but the phase monopulse radar system 10, 100 may include three or more receiving antennas 14-1, . . . , 14-n (n≧3).

In the first and second embodiments, when it is determined that a phase inversion occurs to any one of the received signals, the target detecting unit 24, 102 does not use the azimuth detected based on the phase difference Δφ of the received signals as the target azimuth in the control operation. However, the invention is not limited to this arrangement. When it is determined that a phase inversion occurs to any one of the received signals, the target detecting unit 24, 102 may not use the phase difference Δφ for detection of the azimuth of the target.

While the predetermined frequency range that is centered at the peak frequency is defined as the frequency range around the peak frequency, or the vicinity of the peak frequency, in the first and second embodiments, the vicinity of the peak frequency may be within a given frequency range including the peak frequency fr at which the amplitude reaches its maximum in the frequency spectrum.

1. A phase monopulse radar system, comprising:
a transmitting antenna that transmits a transmission signal;
a plurality of receiving antennas that receive reflected waves of the transmission signal as received signals;
a target azimuth detecting portion that detects an azimuth of a target based on a phase difference of the received signals received by said plurality of receiving antennas;
a phase inversion determining portion that determines whether a phase inversion occurs to any one of the received signals, at around a peak frequency of a frequency spectrum of the received signal; and
a detection object excluding portion that does not use an azimuth based on the phase difference as a target azimuth, when the phase inversion determining portion determines that the phase inversion occurs.

2. The phase monopulse radar system according to claim 1, wherein the phase inversion determining portion determines that the phase inversion occurs, when an amount of change of the phase difference in the vicinity of the peak frequency is equal to or larger than a predetermined value.

3. The phase monopulse radar system according to claim 2, wherein the phase inversion determining portion determines that the phase inversion occurs, when a difference between a maximum value and a minimum value of the phase difference within a predetermined frequency range around the peak frequency is equal to or larger than the predetermined value.

4. The phase monopulse radar system according to claim 1, wherein the phase inversion determining portion determines that the phase inversion occurs, when a difference in an integrated value of phase variations in the received signal received by each of the receiving antennas within a predetermined frequency range around the peak frequency, between the receiving antennas, is equal to or larger than a predetermined value.

5. The phase monopulse radar system according to claim 1, wherein the detection object excluding portion excludes the received signals received by said plurality of receiving antennas, from objects based on which the target azimuth detecting portion detects the azimuth of the target, when the phase inversion determining portion determines that the phase inversion occurs.

6. The phase monopulse radar system according to claim 1, further comprising a target distance detecting portion for detecting a distance from the system to the target based on the peak frequency.

7. A phase monopulse radar system comprising:
a transmitting portion that transmits a transmission signal;
a plurality of receiving portions that respectively receives reflected waves including the transmission signal reflected from a target, as received signals;
a beat signal generating portion that generates beat signals from the received signals; a spectrum generating portion that generates a plurality of frequency spectra from the beat signals;
an azimuth detecting portion that detects an azimuth of the target based on a phase difference between said plurality of frequency spectra; and
a phase inversion determining portion that determines whether a phase inversion occurs to any one of the received signals, within a predetermined frequency range including a frequency at which an amplitude of the received signal reaches a maximum in the corresponding frequency spectrum, wherein
the azimuth detecting portion does not use the phase difference for detection of the azimuth of the target, when the phase inversion determining portion determines that the phase inversion occurs.

8. A target detecting method comprising:
transmitting a transmission signal;
receiving reflected waves including the transmission signal reflected from a target, as received signals;
generating beat signals from the received signals;
generating a plurality of frequency spectra from the beat signals;
detecting an azimuth of the target based on a phase difference between said plurality of frequency spectra; and
determining whether a phase inversion occurs to any one of the received signals, within a predetermined frequency range including a frequency at which an amplitude of the received signal reaches a maximum in the corresponding frequency spectrum, wherein the phase difference is not used for detection of the azimuth of the target, when it is determined that the phase inversion occurs to any one of the received signals.
